(19) United States
(12) Patent Application Publication
(10) Pub. No.: US 2006/0269750 A1
(43) Pub. Date: Nov. 30, 2006

(54) Phosphor for low-voltage electron beam, method of producing the same, and vacuum fluorescent display

(76) Inventors: Hitoshi Tsuji, Ise-shi (JP); Hitomi Kitamura, Ise-shi (JP)

Correspondence Address: James V. Costigan, 1185 Avenue of the Americas, New York, NY, 10033, US

(21) Appl. No.: 11/409,728

(22) Filed: Apr. 24, 2006

Related U.S. Application Data
(63) Continuation-in-part of application No. 11/406,163, filed on Apr. 18, 2006.

(30) Foreign Application Priority Data
Apr. 21, 2005 (JP) P2005-123922

(51) Int. Cl. C09K 11/08; C09K 11/77; C09K 11/54; B32B 5/16; B32B 19/00

(52) U.S. Cl. 428/403; 252/301.4 R; 252/301.6 R; 252/301.5; 252/301.4 F; 252/301.6 F; 252/301.6 S; 428/404; 252/301.4 S

(57) ABSTRACT

Nano-particles of an electrically conductive oxide adhere to the surface of particles of a phosphor for low-voltage electron beams. The average diameter of nano-particles of the electrically conductive oxide is in the range of 5 to 100 nm. The weight percentage of the nano-particles of the electrically conductive oxide to the entire phosphor is 0.01 to 10. A vacuum fluorescent display uses the phosphor for low-voltage electron beams.

### BACKGROUND OF THE INVENTION

The present invention relates to a phosphor for low-voltage electron beams, a method of producing the phosphor, and a vacuum fluorescent display using the phosphor.

A phosphor for low-voltage electron beams for use in a vacuum fluorescent display, an FED, and the like are demanded to be electrically conductive, because it is necessary to escape incident electrons for exciting the phosphor from the surface of the phosphor to an anode. A green phosphor ZnO:Zn and a red phosphor SnO₂:Eu are electrically conductive. But phosphors ZnS, CaS, ZnGa₂O₄, SrTiO₃, CaTiO₃, ZnCdS, Y₂O₃, and Y₂O₂S are insufficiently electrically conductive. Therefore electrically conductive materials not inhibiting the property of the phosphor are added as a conductivity-imparting agent to particles of the phosphor at 1 to 20 wt %. As the electrically conductive materials, electrically conductive oxides such as indium tin oxide (ITO), In₂O₃, SnO₂, ZnO, and the like are used.

These conductivity-imparting agents do not emit light. When a large amount of the electrically conductivity-imparting agent is added to the phosphor, the luminance of the phosphor decreases. Therefore it is necessary to use a necessary minimum amount of the conductivity-imparting agent and adhere the conductivity-imparting agent to the surface of the phosphor without coagulating the conductivity-imparting agent.

Even though the conductivity-imparting agent is sufficiently dispersed to adhere it to the surface of the phosphor, electrically conductive particles separate partly from the surface of the phosphor, when an organic solvent, an organic binder, and the phosphor to which the electrically conductive particles are kneaded to form phosphor paste for printing.

Thus it is necessary to add electrically conductive particles to the phosphor particles as the conductivity-imparting agent in an amount larger than a necessary amount. Consequently the phosphor has a low luminance. To overcome this problem, as a method of fixing the electrically conductive particles to the phosphor particles, a method of adhering the electrically conductive particles to the phosphor particles with a water-soluble binder which is not dissolved in the phosphor paste is proposed (Japanese Patent Application Laid-Open No. 61-127783). This method solves the problem of the separation of the electrically conductive particles from the surface of the phosphor by uniformly adhering the electrically conductive particles to the surface of the phosphor with the water-soluble binder, but requires complicated steps. Thus this method is unsuitable for a mass production.

In addition, a phosphor having an electrically conductive coating layer on the surfaces of particles (Japanese Unexamined Patent Publication No. 2003-511548) is known. This coating layers requires a successive electric path. In this case, the electrically conductive coating layer has a large thickness. Consequently the phosphor for low-voltage electron beams has a low luminance.

The following proposals are also made: phosphor particles, for a plasma display panel, coated with a metal oxide (Japanese Patent Application Laid-Open No. 10-195428), a method of coating micrometer-sized inorganic particles (Japanese Unexamined Patent Publication No. 2002-544365), and a method of coating the surface of particles (Japanese Patent Application Laid-Open No. 2004-137482) In these proposals, the coating layer is formed on the surfaces of particles. Thus the thickness of the coating layer increases. Consequently the phosphor for low-voltage electron beams has a low luminance.

### SUMMARY OF THE INVENTION

The present invention has been made in view of the above-described problems. Therefore it is an object of the present invention to provide a phosphor, for low-voltage electron beams, which has a high luminance by adhering nano-particles of an electrically conductive oxide to the surface of particles thereof as a conductivity-imparting agent in a simple producing process, a method of producing the phosphor, and a vacuum fluorescent display using the phosphor.

The nano-particles of the electrically conductive oxide adhere to the surface of particles of the phosphor for low-voltage electron beams. The average diameter of the nano-particles of the electrically conductive oxide is in the range of 5 to 100 nm.

In the above-described phosphor for low-voltage electron beams, the weight percentage of the nano-particles of the electrically conductive oxide to the entire phosphor is 0.01 to 10.

The method of the present invention of producing the phosphor for low-voltage electron beams includes the steps of dispersing nano-particles of the electrically conductive oxide having an average particle diameter of 5 to 100 nm in an organic solvent; mixedly dispersing particles of the phosphor for low-voltage electron beams in an obtained dispersion; and evaporating the organic solvent dispersing the particles of the phosphor for low-voltage electron beams to which the nano-particles of the electrically conductive oxide have adhered.

The vacuum fluorescent display of the present invention irradiates the phosphor formed on an anode substrate with low-voltage electron beams generated at a cathode to allow the phosphor to emit light.

The average diameter of the nano-particles of the electrically conductive oxide is in the range of 5 to 100 nm. Thus the nano-particle of the electrically conductive oxide has a much higher surface energy than those of conventional electrically conductive particles. When the nano-particles adhere to the surface of the phosphor for low-voltage electron beams, the surface energy thereof becomes low. Thereby the nano-particles do not separate from the surface of the phosphor. Consequently it is possible to decrease the addition amount of the electrically conductive oxide and increase the luminance of the phosphor.

### BRIEF DESCRIPTION OF THE DRAWINGS

FIG. 1 is a sectional view showing a vacuum fluorescent display.

FIG. 2 is an electron microscope photograph showing particles of a phosphor.

FIG. 3 shows results obtained by measuring emission luminance of the phosphor by using the concentration of particles of an oxide as a parameter.

### DETAILED DESCRIPTION OF THE PREFERRED EMBODIMENTS

The average particle diameter of nano-particles of an electrically conductive oxide which can be used in the present invention is in the range of 5 to 100 nm and favorably in the range of 5 to 50 nm. When the average particle diameter is less than 5 nm, the nano-particles coagulate with one another. As a result, it is difficult to disperse them in an organic solvent in a producing method that will be described later. When the average particle diameter exceeds 100 nm, the nano-particles have low adhesion to particles of a phosphor. In the present invention, the average particle diameter can be measured by a specific surface area method or the like.

By using the nano-particles of the electrically conductive oxide having the average diameter not more than 100 nm and favorably not more than 50 nm, the surface area of the nano-particle increases greatly. Thereby the surface activity of the nano-particle becomes high. Consequently the surface energy of the nano-particle becomes much higher than that of the conventional conductive particle (average particle diameter: about 0.3 μm). Therefore when the electrically conductive nano-particles are dispersed and adhered to the phosphor particles, the surface energy of the electrically conductive nano-particle becomes low, and the adhesion thereof to the phosphor particles becomes very high. Consequently when an organic solvent, an organic binder, and a phosphor to which the electrically conductive particles have adhered are kneaded to produce phosphor paste, the electrically conductive nano-particles hardly separate from the surface of the phosphor.

It is preferable that the ratio of the average diameter of the nano-particles of the electrically conductive oxide that can be used in the present invention to the average particle diameter of the particles of the phosphor for low-voltage electron beams is in the range of 1/10 to 1/100. When the ratio exceeds 1/10, the nano-particles of the electrically conductive oxide has a low adhesion to the phosphor particles and the resulting phosphor has a low luminance. When the ratio is less than 1/100, the nano-particles coagulate with one another.

The average diameter of the nano-particles of the electrically conductive oxide that can be used in the present invention is about ⅙ of the average diameter of particles of electrically conductive oxides conventionally used. Therefore a necessary minimum amount of the electrically conductive oxide to be added to the phosphor particles is ½ to ⅕ of the amount of the conventional electrically conductive oxide to be added thereto.

The following nano-particles of the electrically conductive oxides can be used in the present invention: ZnO, In₂O₃, indium tin oxide (ITO), SnO₂, Nb₂O₅, TiO₂, and WO₃. These nano-particles can be used singly or as mixtures thereof.

It is preferable to produce the nano-particles of the electrically conductive oxide by a vapor deposition. A preferable producing method is described in Japanese Patent Application Laid-Open No. 11-278838. In this method, ZnO is produced as follows: plasma flame of an argon gas is generated from a cathode electrode by using metal zinc as a consumption anode electrode. The metal zinc is heated and evaporated. The vapor of the metal zinc is oxidized and cooled. To produce In₂O₃ in this method, the nano-particle of the electrically conductive oxide can be produced by using metal indium as the material.

As the phosphor for low-voltage electron beams that can be used in the present invention, it is possible to use phosphors that emit light easily when they are irradiated with low-voltage electron beams for use in a vacuum fluorescent display. For example, phosphors consisting of sulfides and oxides can be used. As phosphors consisting of sulfides, it is possible to use (Zn, Cd) S:Ag, Cl phosphor containing (Zn, Cd) S as its matrix and (ZnS Mn, ZnS:Au, Al, ZnS:Ag, Cl, ZnS:Cu, Al) phosphor containing ZnS as its matrix. As phosphors consisting of oxides, it is possible to use phosphors consisting of (Zn, Mg) O:Zn, ZnGa₂O₄:Mn, (Zn, Mg) Ga₂O₄:Mn, (Zn, Al) Ga₂O₄:Mn, ZnSiO₄:Mn, SrTiO₃ Pr, Al, SnO₂:Eu, Y₂O₂S:Eu, and CaTiO₃:Pr. The average particle diameter of these phosphors is in the range of 0.5 to 5 μm.

The phosphor of the present invention for low-voltage electron beams can be obtained by adhering the nano-particles of the electrically conductive oxide to the surface of particles of the phosphor for low-voltage electron beams. The weight percentage of the nano-particles of the electrically conductive oxide to the entire phosphor (particles of phosphor+nano-particles of electrically conductive oxide) is in the range of 0.01 to 10 and favorably 0.1 to 8. If the weight percentage is less than 0.01, conductivity of the electrically conductive oxide cannot be imparted to the phosphor. Thus the phosphor is incapable of maintaining a necessary luminance. If the weight percentage exceeds 10, the luminance starts to drop.

The method of adhering the nano-particles of the electrically conductive oxide to the surface of the particles of the phosphor for low-voltage electron beams includes a first step of dispersing the nano-particles of the electrically conductive oxide in an organic solvent; a second step of dispersedly mixing the particles of the phosphor for low-voltage electron beams with an obtained dispersion; and a third step of evaporating the organic solvent dispersing the particles of the phosphor for low-voltage electron beams to which the nano-particles of the electrically conductive oxide have adhered.

The following organic solvents can be used in the first process: an aromatic hydrocarbon solvent such as toluene, xylene, and solvent naphtha; ketone solvents such as acetone, methyl ethyl ketone, methyl isobutyl ketone; an ether solvent such as dibutyl ether; an ester solvent such as ethyl acetate; and an alcohol solvent such as ethyl alcohol, normal propyl alcohol, and isopropyl alcohol. The alcohol solvent is most favorable of these solvents because the alcohol solvent leaves least amount of residue.

It is preferable to suspend the nano-particles of the electrically conductive oxide in the solvent and thereafter mechanically disperse them by using an ultrasonic homogenizer or the like.

After the nano-particles of the electrically conductive oxide are dispersed, the particles of the phosphor are mixed with the dispersion. Thereafter the ultrasonic homogenizer is used again to mechanically disperse the phosphor particles. Thereafter the organic solvent is removed by evaporation to obtain the phosphor for low-voltage electron beams to which the nano-particles of the electrically conductive oxide have adhered. The organic solvent can be removed by evaporation under a reduced pressure, at a room temperature or by frozen-drying.

The above-described phosphor for low-voltage electron beams is prepared as printing paste. Thereafter the printing paste is printed onto a substrate, dried, and burned out to obtain an anode substrate. The nano-particles of the electrically conductive oxide keeps adhering to the surface of the phosphor even after these steps are conducted. Therefore even though the amount of the electrically conductive oxide added to the phosphor particles is smaller than that of a conventional electrically conductive material, the electrically conductive oxide increases the luminance of the phosphor.

The printing paste is obtained by dissolving the phosphor for low-voltage electron beams and binder resin in a solvent.

As the binder resin, known resin for use in the phosphor for low-voltage electron beams can be used. The following cellulose derivatives can be used as preferable binder resin:ethyl cellulose, methyl cellulose, cellulose acetate, and carboxymethylcellulose.

As the above-described solvent, the following known solvents, for use in screen printing, having a high boiling point can be used: carbitols such as butyl carbitol and butyl carbitol acetate; α-terpineol; and 2-phenoxyethanol.

The steps of performing printing, drying, and burning out the printing paste can be conducted on an anode pattern by using a known method.

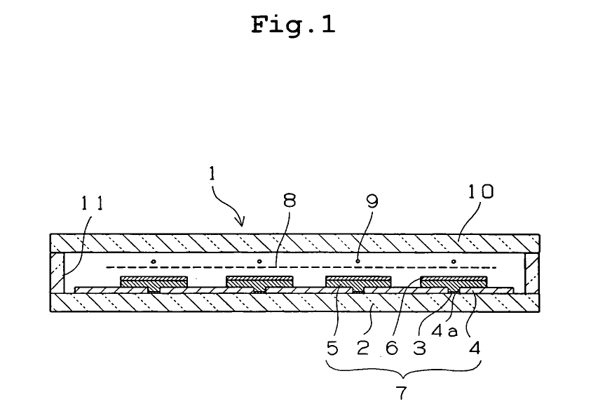

The vacuum fluorescent display of the present invention is described below with reference to FIG. 1. FIG. 1 is a sectional view showing the vacuum fluorescent display.

A vacuum fluorescent display 1 has an anode substrate 7, a grid 8 and a cathode 9 both disposed over the anode substrate 7. The vacuum fluorescent display 1 is sealed, and a vacuum is drawn therein by using a face glass 10 and a spacer glass 11. Low-voltage electron beams generated at the cathode 9 strike a phosphor layer 6 disposed on the anode substrate 7. Thereby the phosphor layer 6 emits light.

To obtain the anode substrate 7, after forming a circuit layer 3 by using a printing coating method with electrically conductive paste containing silver or by using an aluminum thin film method, an insulation layer 4 is formed over almost an entire surface except a through-hole 4a by the printing coating method using low-melting point frit glass paste. Thereafter an anode 5 electrically connected to the phosphor layer 6 through the through-hole 4a is formed by the printing coating method using graphite paste. After the phosphor layer 6 is applied to the anode 5 by the printing coating method, it is burned out to obtain the anode substrate 7.

The nano-particles of the electrically conductive oxide keep adhering uniformly to the surface of the phosphor layer 6 even after the phosphor 6 is applied to the anode 5 by the printing coating method and burned out. Therefore the nano-particles improve the emission luminance of the phosphor layer 6 even when the electrically conductive oxide is used in a small amount.

### EXAMPLES 1 THROUGH 7

After nano-particles of zinc oxide (ZnO) having an average particle diameter of 50 nm was suspended in isopropyl alcohol (IPA) which is an organic solvent, the zinc oxide was sufficiently dispersed by using an ultrasonic homogenizer of 300 W. After a predetermined amount of a phosphor consisting of ZnS:Ag, Cl having an average particle diameter of 3 μm was supplied to the dispersion, the nano-particles of the zinc oxide and particles of the phosphor consisting of ZnS:Ag, Cl were dispersed sufficiently by using the ultrasonic homogenizer. Thereafter the isopropyl alcohol was evaporated, while the suspended solution was being stirred with a rotary evaporator. As a result, a phosphor composed of ZnS:Cl and the nano-particles of zinc oxide which firmly adhered to the surface of ZnS:Ag, Cl was obtained.

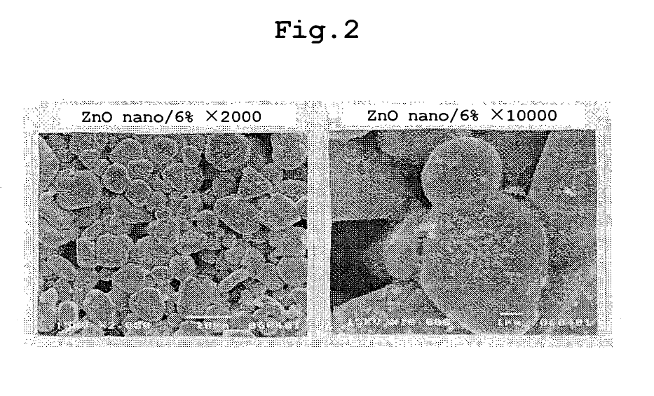

FIG. 2 is an electron microscope photograph showing particles of the phosphor composed of the particles of ZnS:Ag, Cl and the nano-particles of zinc oxide which adhered to the surface thereof. As shown in FIG. 2, the nano-particles of the zinc oxide uniformly adhered to the surface of the particles of ZnS:Ag, Cl

The weight percentage of the nano-particles of the electrically conductive oxide to the entire phosphor (nano-particles of electrically conductive oxide+particles of phosphor) was 0.1 in example 1, 0.5 in example 2, 1.0 in example 3, 1.5 in example 4, 2.0 in example 5, 4.0 in example 6, and 6.0 in example 7.

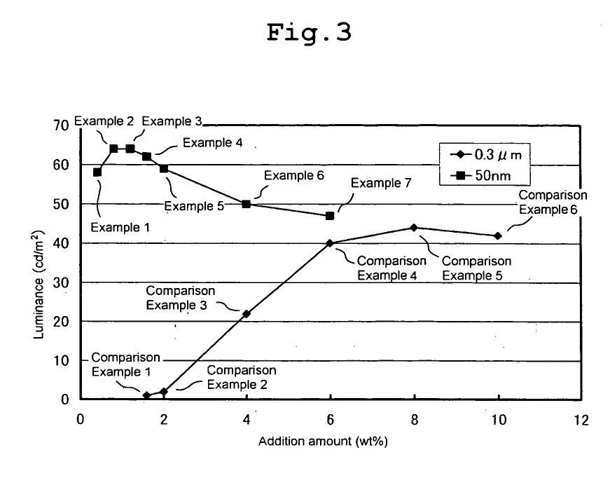

After the printing paste prepared by using the phosphor of each of the embodiments was applied to a substrate by the printing coating method, the printing paste was burned out to obtain an anode substrate. Thereafter a vacuum fluorescent display of each example shown in FIG. 1 was assembled to measure the emission luminance thereof by using the concentration of the nano-particle of the oxide as a parameter. FIG. 3 shows the results.

### COMPARISON EXAMPLES 1 THROUGH 6

Except that zinc oxide (ZnO) having an average particle diameter of 300 nm was used instead of the zinc oxide (ZnO) having the average particle diameter of 50 nm, a phosphor composed of ZnS:Ag, Cl and the nano-particles of zinc oxide which adhered to the surface of ZnS:Ag, Cl was obtained in a manner similar to that of example 1. The weight percentage of the nano-particles of the zinc oxide to the entire phosphor (nano-particles of zinc oxide+particles of phosphor) was 1.5 in comparison example 1, 2.0 in comparison example 2, 4.0 in comparison example 3, 6.0 in comparison example 4, 8.0 in comparison example 5, 10.0 in comparison example 6.

A vacuum fluorescent display of each comparison example shown in FIG. 1 was assembled in a manner similar to that of example 1 to measure the emission luminance thereof by using the concentration of the nano-particle of the oxide as a parameter. FIG. 3 shows the results.

### EXAMPLE 8 AND COMPARISON EXAMPLE 7

After nano-particles of zinc oxide (ZnO) having an average particle diameter of 50 nm was suspended in isopropyl alcohol (IPA) which is an organic solvent, the zinc oxide was sufficiently dispersed by using an ultrasonic homogenizer of 300 W. After a predetermined amount of a phosphor consisting of ZnGa₂O₄: Mn having an average particle diameter of 2 μm was supplied to the dispersion, the nano-particles of the zinc oxide and particles of the phosphor consisting of ZnGa₂O₄:Mn were dispersed sufficiently by using the ultrasonic homogenizer. Thereafter the isopropyl alcohol was evaporated, while the suspended solution was being stirred with a rotary evaporator. As a result, a phosphor composed of ZnGa₂O₄:Mn and the nano-particles of zinc oxide which firmly adhered to the surface of ZnGa₂O₄:Mn was obtained.

The weight percentage of the nano-particles of the electrically conductive oxide to the entire phosphor (nano-particles of electrically conductive oxide+particles of phosphor) was 6.0.

In comparison example 7, the weight percentage of the particles of zinc oxide (ZnO) having an average particle diameter of 300 nm to the entire phosphor (nano-particles of zinc oxide+particles of phosphor (ZnGa₂O₄:Mn)) was 12.0.

By using the obtained phosphor, a vacuum fluorescent display shown in FIG. 1 was assembled in a manner similar to that of example 1 to measure the emission luminance thereof. The result was that the emission luminance of example 8 was 130 supposing that the emission luminance of comparison example 7 was 100.

### EXAMPLE 9 AND COMPARISON EXAMPLE 8

After nano-particles of zinc oxide (ZnO) having an average particle diameter of 50 nm was suspended in isopropyl alcohol (IPA) which is anorganic solvent, the zinc oxide was sufficiently dispersed by using an ultrasonic homogenizer of 300 W. After a predetermined amount of a phosphor consisting of SrTiO₃:Pr having an average particle diameter of 2 μm was supplied to the dispersion, the nano-particles of the zinc oxide and particles of the phosphor consisting of SrTiO₃:Pr were dispersed sufficiently by using the ultrasonic homogenizer. Thereafter the isopropyl alcohol was evaporated, while the suspended solution was being stirred with a rotary evaporator. As a result, a phosphor composed of SrTiO₃:Pr and the nano-particles of zinc oxide which firmly adhered to the surface of SrTiO₃:Pr was obtained.

The weight percentage of the nano-particles of the electrically conductive oxide to the entire phosphor (nano-particles of electrically conductive oxide+particles of phosphor) was 8.0.

In comparison example 8, the weight percentage of the particles of zinc oxide (ZnO) having an average particle diameter of 300 nm to the entire phosphor (nano-particles of zinc oxide+particles of phosphor (SrTiO₃:Pr)) was 14.0.

By using the obtained phosphor, a vacuum fluorescent display shown in FIG. 1 was assembled in a manner similar to that of example 1 to measure the emission luminance thereof. The result was that the emission luminance of example 9 was 140, supposing that the emission luminance of comparison example 8 was 100.

### EXAMPLE 10 AND COMPARISON EXAMPLE 9

After nano-particles of zinc oxide (ZnO) having an average particle diameter of 50 nm was suspended in isopropyl alcohol (IPA) which is an organic solvent, the zinc oxide was sufficiently dispersed by using an ultrasonic homogenizer of 300 W. After a predetermined amount of a phosphor consisting of CaTiO₃:Pr having an average particle diameter of 3 μm was supplied to the dispersion, the nano-particles of the zinc oxide and particles of the phosphor consisting of CaTiO₃:Pr were dispersed sufficiently by using the ultrasonic homogenizer. Thereafter the isopropyl alcohol was evaporated, while the suspended, solution was being stirred with a rotary evaporator. As a result, a phosphor composed of CaTiO₃:Pr and the nano-particles of zinc oxide which firmly adhered to the surface of CaTiO₃:Pr was obtained.

The weight percentage of the nano-particles of the electrically conductive oxide to the entire phosphor (nano-particles of electrically conductive oxide+particles of phosphor) was 4.0.

In comparison example 9, the weight percentage of the particles of zinc oxide (ZnO) having an average particle diameter of 300 nm to the entire phosphor (nano-particles of zinc oxide+particles of phosphor (CaTiO₃:Pr)) was 10.0.

By using the obtained phosphor, a vacuum fluorescent display shown in FIG. 1 was assembled in a manner similar to that of example 1 to measure the emission luminance thereof. The result was that the emission luminance of example 10 was 140 supposing that the emission luminance of comparison example 9 was 100.

In the phosphor of the present invention, the nano-particles of the electrically conductive oxide having the average particle diameter in the range of 5 to 100 nm adhere to the surface of the particles of the phosphor. Therefore the nano-particles of the electrically conductive oxide improves the emission luminance of the phosphor, even when the electrically conductive oxide is used in a small amount. Thereby the vacuum fluorescent display using the phosphor is excellent in its initial luminance and thus superior in its display quality. Thus the phosphor of the present invention is applicable to various types of vacuum fluorescent displays.

1. A phosphor for low-voltage electron beams comprising: particles of said phosphor; and an electrically conductive oxide which adheres to surfaces of said particles of said phosphor, wherein said electrically conductive oxide consists of nano-particles having an average particle diameter in a range of 5 to 100 nm; and said nano-particles independently adhere to surfaces of said particles of said phosphor.

2. The phosphor according to claim 1, wherein weight percentage of said nano-particles of said electrically conductive oxide to an entire phosphor is 0.01 to 10 wt %.

3. The phosphor according to claim 1, wherein said nano-particles of said electrically conductive oxides is at least one compound selected from the group consisting of ZnO, In2o3, indium tin oxide (ITO), Sno2, Nb2O5, TiO2 and WO3.

4. The phosphor according to claim 1, wherein said phosphor particles are capable of emitting light when said phosphor particles are under with low-voltage electron beams for use in a vacuum fluorescent display.

5. The phosphor according to claim 4, wherein an average diameter of said particles of said phosphor is in a range of 0.5 to 5 μm.

6. The phosphor according to claim 4, wherein said phosphor is at least one phosphor selected from the group consisting of (Zn, Cd) S:Ag, Cl phosphor; ZnS:Mn phosphor; ZnS:Au, Al phosphor; ZnS:Ag, Cl phosphor; ZnS:Cu, Al phosphor; (Zn, Mg) O:Zn phosphor; ZnGa2O4:Mn phosphor; (Zn, Mg) Ga2O4:Mn phosphor; (Zn, Al) Ga2O4:Mn phosphor; ZnSiO4:Mn phosphor; SrTiO3:Pr, Al phosphor; SnO2:Eu phosphor; Y2O2S:Eu phosphor and CaTiO3:Pr phosphor.

7. A method for producing a phosphor for low-voltage electron beams according to claim 1, comprising the steps of: dispersing nano-particles of an electrically conductive oxide having an average diameter of 5 to 100 nm in an organic solvent; mixedly dispersing particles of said phosphor for low-voltage electron beams in an obtained dispersion; and evaporating said organic solvent.

8. The method according to claim 7, wherein said organic solvent is at least one solvents selected from the group consisting of aromatic hydrocarbon solvents; ketone solvents; ether solvents; ester solvents; and alcohol solvents.

9. A vacuum fluorescent display with said phosphors according to claim 1.
